(19) United States
(12) Patent Application Publication
(10) Pub. No.: US 2008/0029664 A1
(43) Pub. Date: Feb. 7, 2008

(54) Electronic device with pad height adjustable

(75) Inventor: Kao-Yu Hsu, Taipei City (TW)

Correspondence Address: RABIN & Berdo, PC, 1101 14TH STREET, NW, SUITE 500, WASHINGTON, DC, 20005, US

(73) Assignee: INVENTEC MULTIMEDIA & TELECOM CORPORATION

(21) Appl. No.: 11/497,372

(22) Filed: Aug. 2, 2006

(51) Int. Cl. A47B 91/00; F16M 11/20

(52) U.S. Cl. 248/188.8

(57) ABSTRACT

An electronic device with pad height adjustable is provided. The device includes a housing with an accommodating hole and a foot with a body and at least one pad. The body is disposed in the accommodating hole and presses against the housing with one of the pads, such that the body protrudes from the surface of the housing. Moreover, a plurality of notches is formed at the outer edge of the accommodating hole, so as to accommodate the rest of the pads. A user can adjust the foot to different heights on various demands.

### BACKGROUND OF THE INVENTION

1. Field of Invention

The present invention relates to a pad of an electronic device. More particularly, the present invention relates to an electronic device with pad height adjustable, wherein the height of the foot protruding from the electronic device is changed to adjust different tilt angles of the electronic device.

2. Related Art

Along with the development and popularization of science and technology, each family has many electronic products, such as personal computer, notebook, city phone or internet protocol phone (IP phone), which make the life of the people more convenient. In order to put the electronic products stably on a table or on the ground, a plurality of feet is installed on the bottom of the electronic products to increase the friction against the table or the ground, so as to balance and stably support the electronic devices, thus preventing the electronic products from directly contacting the disposing plane or being damaged due to swing or collision.

As for an IP phone, usually the conventional foot installed on the phone is simply formed by a plastic pad and a bolt, and a plurality of bolt holes is disposed in the bottom of the electronic device, so as to lock a corresponding number of bolt and plastic pad into the bolt holes, thus making the IP phone blocked up by a height. Alternatively, a supporting foot rest is installed on the bottom of the phone, so as to make the phone depart from the disposing plane for a fixed height.

As the users dispose the IP phone at different positions, they have to adjust the height of the IP phone on practical demands. The method of adjusting the height of each foot is to rotate each plastic pad to the same height, such that the IP phone can lie stably, so it takes too much time to adjust each pad to the same height, which does not deviate from the efficiency requirement of the current society, but also causes unnecessary troubles to the user. Moreover, the manner of adopting a supporting foot rest may result in the increase of the fabricating cost and taking too much disposing space while the height thereof can not be adjusted, which causes many limits when the user selects the disposing position and is quite inconvenient.

For the foot of the conventional art, the height thereof can not be quickly and precisely adjusted, so the user has to spend plenty of time adjusting the height and the tilt angle of the phone; for the supporting foot rest of the conventional art, the height thereof can not be changed and the disposing space is too large, which depart from the practical demands.

### SUMMARY OF THE INVENTION

In view of the above, the present invention provides an electronic device with pad height adjustable, so as to improve the disadvantages in the prior art that it takes too much time to adjust the height of the foot and a lot of disposing space is occupied.

The electronic device with pad height adjustable disclosed by the present invention comprises a housing and a foot. The housing has an accommodating hole, and the foot has a body and at least one pad formed in the body. The body is disposed in the accommodating hole, and presses against the housing with the pad of the body, such that the body protrudes from the surface of the housing.

The function of the present invention is that based on different occasions and requirements from the users, the users may find it convenient to quickly and precisely adjust the electronic device to have the required height and tilt angle, and greatly reduce the volume of the electronic device, so as to meet the market requirement of a light and thin electronic device. Moreover, in the electronic device with pad height adjustable, an elastomer is disposed and bonded to the foot, and an elastic force is provided to make the body of the foot press against the housing, so as to avoid the foot dropping to lose.

The above illustration of the content of the utility model and the following illustration of the embodiments are intended to demonstrate and explain the principle of the utility model, and provide further explanations for the claims of the utility model.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic exploded view of the first embodiment of the present invention.

FIG. 2 is a side view of the first embodiment of the present invention.

FIG. 3 is a back view of the first embodiment of the present invention.

FIG. 4A is a side sectional view of the pad at a first position according to the first embodiment of the present invention.

FIG. 4B is a side sectional view of the pad at a second position according to the first embodiment of the present invention.

FIG. 4C is a side sectional view of the pad at a third position according to the first embodiment of the present invention.

FIG. 5 is a schematic exploded view of the second embodiment of the present invention.

FIG. 6 is a side view of the second embodiment of the present invention.

FIG. 7 is a back view of the second embodiment of the present invention.

FIG. 8A is a side sectional view of the pad at a first position according to the second embodiment of the present invention.

FIG. 8B is a side sectional view of the pad at a second position according to the second embodiment of the present invention.

FIG. 8C is a side sectional view of the pad at a third position according to the second embodiment of the present invention.

### DETAILED DESCRIPTION OF THE INVENTION

To acquire further understandings to the objectives, structure, features and functions of the present invention, they are illustrated in detail below with reference to the related embodiments.

According to the electronic device with pad height adjustable disclosed by the present invention, the electronic device may be a notebook, telephone, projector or other portable electronic devices. In the following detailed description of the present invention, IP phone is adopted as an optimal embodiment of the present invention. However, the appended drawings are provided for reference and illustration, and are not used to limit the present invention.

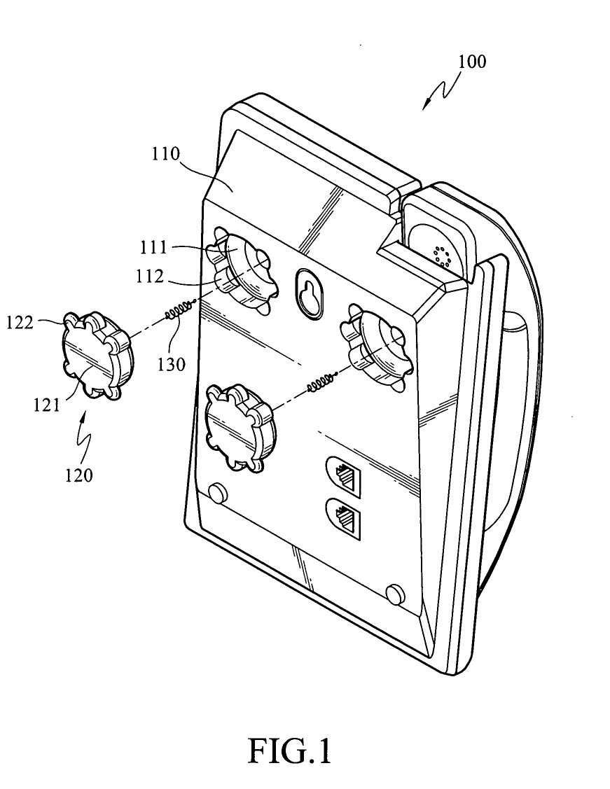

FIG. 1 is a schematic exploded view of the first embodiment of the present invention. As shown in the figure, an electronic device with pad height adjustable 100 comprises a housing 110, a foot 120 and an elastomer 130. The foot 120 has a body 121 and a plurality of pads 122 formed in the body 121. An accommodating hole 111 is formed in the back of the housing 110 of the electronic device 100, and a plurality of notches 112 is formed in the radial direction along the edge of the accommodating hole 111. The body 121 is disposed in the accommodating hole 111. When the body 121 is accommodated in the accommodating hole 111, at least one of the pads 122 selectively presses against the housing 110, and the rest of the pads 122 are respectively nested in each of the notches 112, so as to make a part of the body 121 protrude from the surface of the housing 110. Further, the thickness of each pad 122 is not equal to the thickness of the rest of the pads 122, so when different pads 122 press against the housing 110, the height of the body 121 protruding from the surface of the housing 110 is changed.

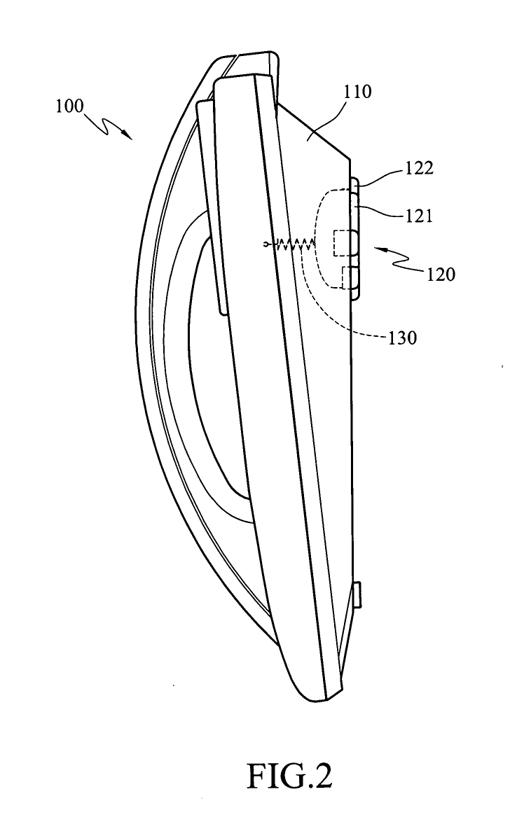

As shown in FIG. 2, the elastomer 130 is disposed in the housing 110, and bonded to one side of the housing 110 and the body 121, for providing an elastic force to make the body 121 constantly press against the housing 110, and to make the foot 120 fastened in the accommodating hole 111, so as to avoid the dropping and losing of the foot 120. The elastomer 130 of the present invention is a tension spring, for stably providing an elastic force for the foot 120. Further, a side of the main body 121 facing the exterior of the housing 110 is a flat end face, for contacting a plane, such that when the electronic device 110 is disposed on the plane, the housing 110 is supported by the foot 120 to make the electronic device 100 form an included angle with the plane. The included angle is determined by the height of the body 121 of the foot 120 protruding from the housing 110, and the height of the body 121 protruding from the surface of the housing 110 is determined by the thickness of the pad 122 pressing against the housing 110. Therefore, through different pads 122 pressing against the housing 110, the included angle formed between the electronic device 100 and the plane is determined by the pad 122 as the thickness of each pad 122 is different from the rest of the pads 122.

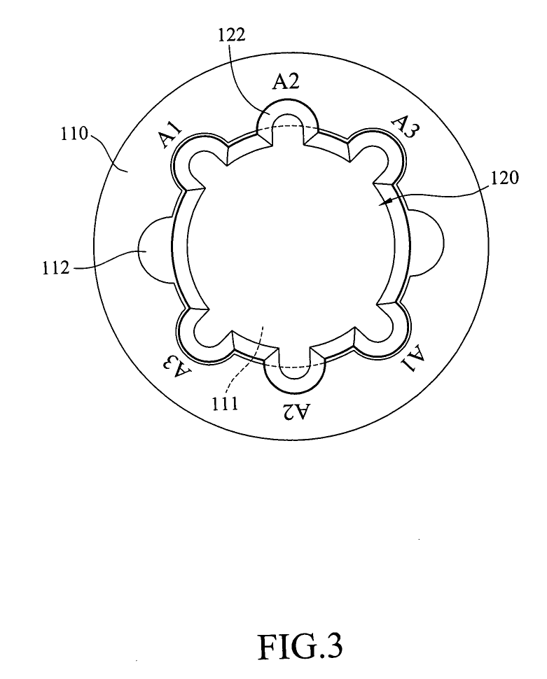

As shown in FIG. 1 and FIG. 3, wherein the foot 120 has three groups of pads 122, which are respectively disposed on one side of the body 121 facing the housing 110 with a fixed distance. Each group of the pads 122 are correspondingly disposed along the radial direction of the body 121, so as to have a first position A1, a second position A2 and a third position A3. The edge of the accommodating hole 111 has three groups of notches 112 corresponding to the positions A1, A2 and A3 of the three groups of pads 122 on the body 121. It should be noted that the foot 120 of the first embodiment disclosed in the present invention is formed by three pads 122 of different thicknesses, and the number of the notches 112 along the edge of the accommodating hole 111 corresponds to that of the pads 122. However, those skilled in the art may also change the design into more than three or less than three pads 122 of different thicknesses and a corresponding number of the notches 112, such that the electronic device 100 may accordingly have different heights, and is not limited to the present embodiment.

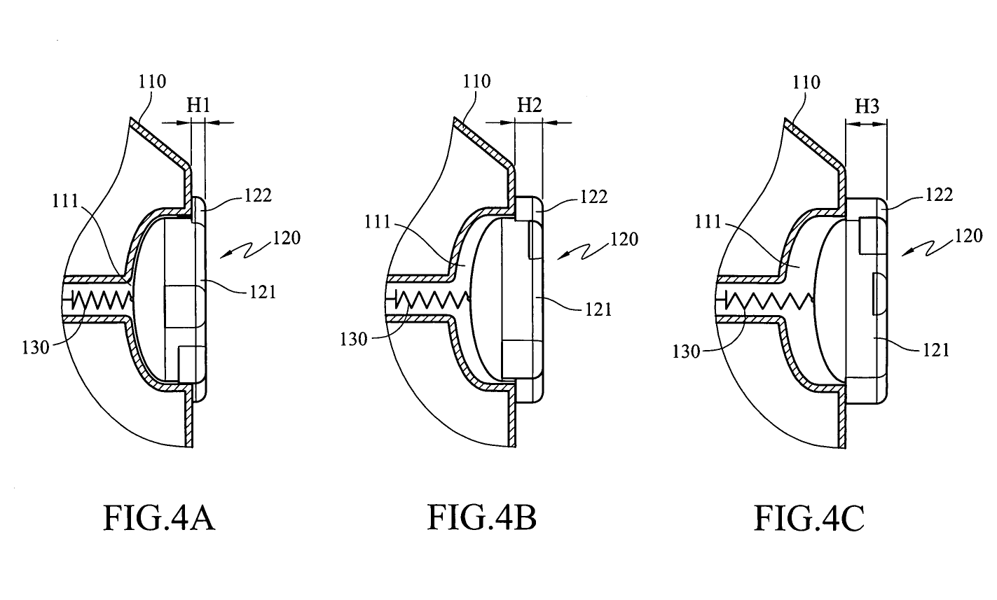

As shown in FIGS. 4A, 4B and 4C, the three pads 122 of the present invention are disposed at the positions A1, A2 and A3 of the body 121, and the heights blocked up thereby are corresponding to a first height H1, a second height H2 and a third height H3.

Therefore, according to different requirements, the user adopts the pad 122 of the required height to press against the housing 110, such that the electronic device 100 meets the practical demand of the user on height. In the present embodiment, the relation of the H1, H2 and H3 is H3>H2>H1, so when the pad 122 at the third position A3 presses against the housing 110, the rest of the pads 122 at A1 and A2 may be blocked up and depart from the surface of the housing 110. However, when the pad 122 at the first position A1 presses against the housing 110, in order to avoid the heights H1 and H2 corresponding to A2 and A3 interfering with A1, the positions A2 and A3 can be nested in the notches 112, so as to make the pads 122 at A2 and A3 embedded into the accommodating hole 111, such that A1 is not interfered due to the height difference. Of course, all the pads 122 can be nested in the notches 112, such that the body 121 is completely embedded into the accommodating hole 111 instead of protruding from the housing 110.

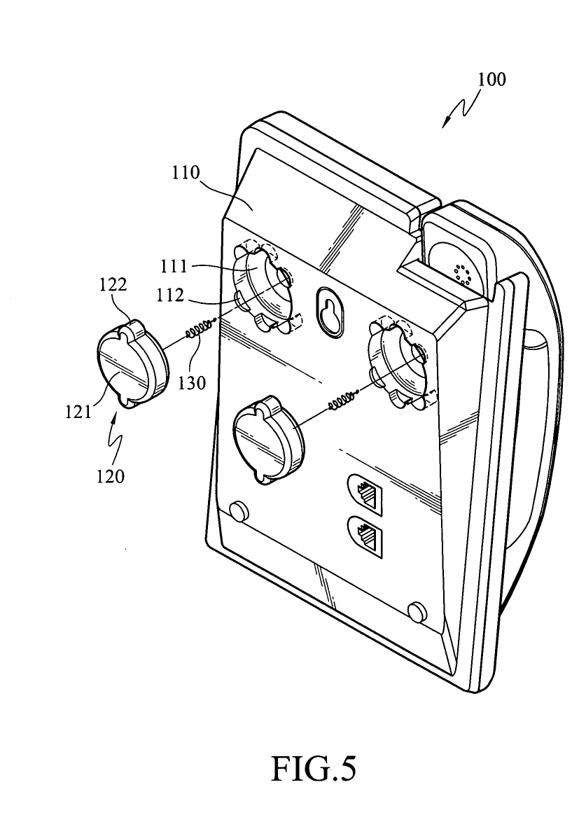

FIG. 5 is a schematic exploded view of the second embodiment of the present invention. It is shown in the figure that the electronic device with pad height adjustable 100 comprises a housing 110, a foot 120 and an elastomer 130. The foot 120 has a body 121 and a pad 122 formed in the body 121. An accommodating hole 111 is formed in the back of the housing 110 of the electronic device 100, and a plurality of notches 112 is formed in the radial direction along the edge of the accommodating hole 111. The body 121 is disposed in the accommodating hole 111. When the body 121 is accommodated in the accommodating hole 111, the pad 122 selectively presses against a notch 112 of the accommodating hole 111, so as to make a part of the body 121 protrude from the surface of the housing 110. Further, the thickness of each notch 112 is not equal to the thickness of the rest of the notches 112. Therefore, when the pad 122 presses against different notches 112, the height of the body 121 protruding from the surface of the housing 110 is changed.

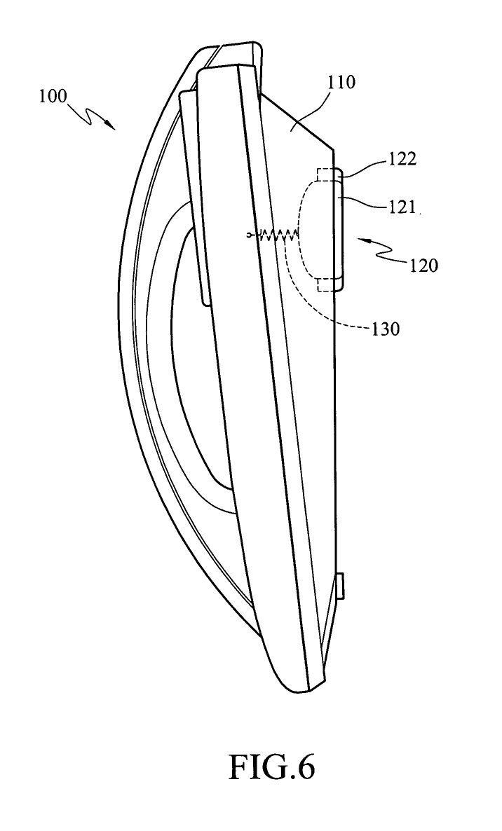

As shown in FIG. 6, the elastomer 130 is disposed in the housing 110, and bonded to one side of the housing 110 and the body 121, for providing an elastic force to make the body 121 constantly press against the housing 110, and to make the foot 120 fastened in the accommodating hole 111, so as to avoid the dropping and losing of the foot 120. The elastomer 130 of the present invention is a tension spring, for stably providing an elastic force for the foot 120. Further, one side of the main body 121 facing the exterior of the housing 110 is a flat end face, for contacting a plane, such that when the electronic device 110 is disposed on the plane, the housing 110 is supported by the foot 120 to make the electronic device 100 form an included angle with the plane. The included angle is determined by the height of the body 121 of the foot 120 protruding from the housing 110, and the height of the body 121 protruding from the surface of the housing 110 is determined by the thickness of the notch 112 of the accommodating hole 111. Therefore, through the pad 122 pressing against the notches 112 of different thicknesses, the included angle of the electronic device 100 with the plane is determined by the notches 112 as the thickness of each notch 112 is different from the rest of the notches 112.

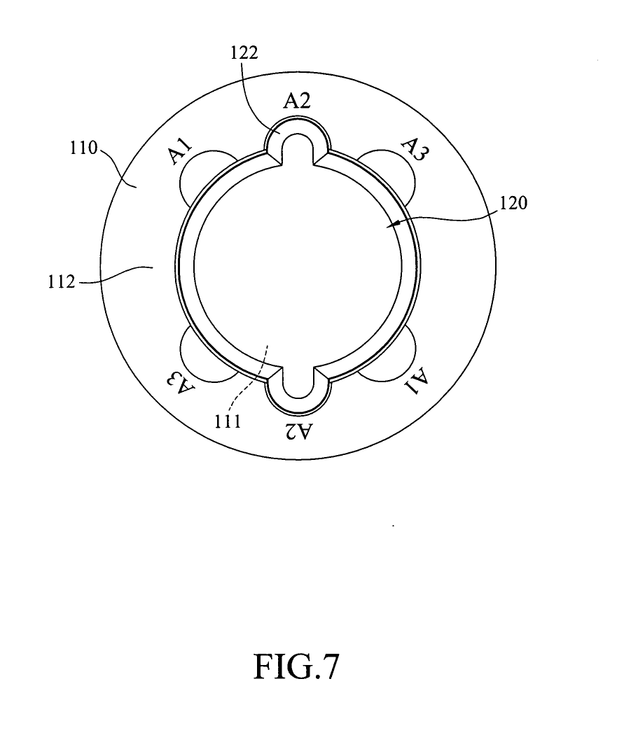

As shown in FIG. 5 and FIG. 7, the accommodating hole 111 has three groups of notches 112 respectively disposed along the edge of the accommodating hole 111 by a fixed distance. Each group of the notches 112 is correspondingly disposed in the radial direction of the accommodating hole 111, thus obtaining a first position A1, a second position A2 and a third position A3. It should be noted that the accommodating hole 111 of the second embodiment disclosed in the present invention has three notches 112 of different thicknesses. However, those skilled in the art can also change the design to more than three or less than three notches 112 of different thicknesses, such that the electronic device 100 accordingly has different heights, and is not limited to the present embodiment.

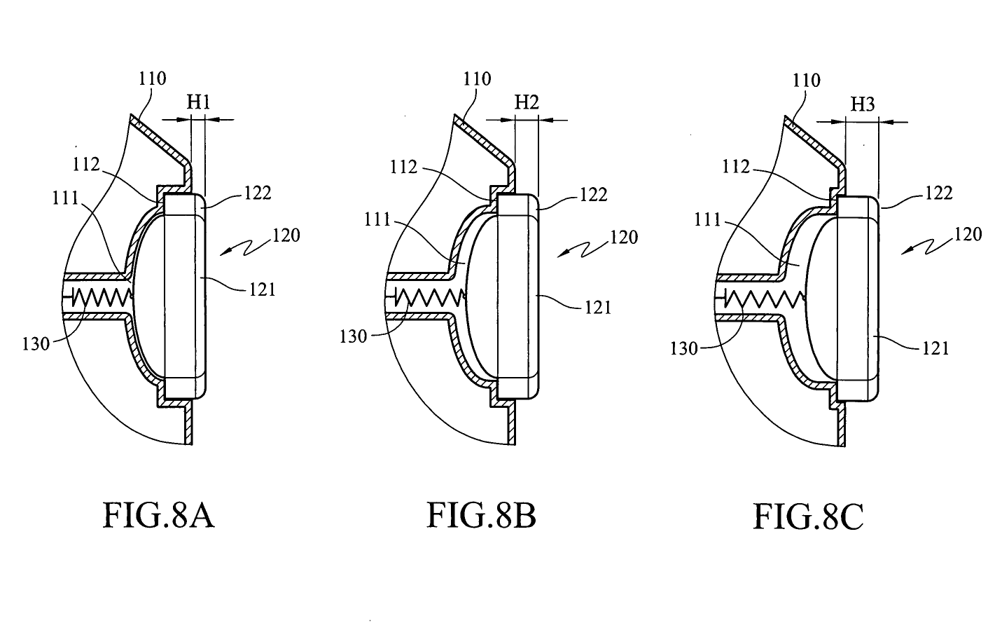

As shown in FIGS. 8A, 8B and 8C, the pad 122 of the present invention presses against the positions A1, A2 and A3 of the three groups of notches 112, and the heights blocked up thereby are corresponding to a first height H1, a second height H2 and a third height H3. Therefore, according to different requirements, the user makes the pad 122 press against the notches 112 of the required height, such that the electronic device 100 meets the practical demand of the user on height. In the present embodiment, the relation of the H1, H2 and H3 is H3>H2>H1, so when the pad 122 presses against the notch 112 at the third position A3, the rest of the notches 112 at A1 and A2 are in a state of open.

Compared with the conventional art, the electronic device with pad height adjustable disclosed by the present invention can quickly and precisely adjusts the electronic device to the height and the tilt angle required by the user, and greatly reduces the volume of the electronic device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electronic device with pad height adjustable, comprising:
a housing, with an accommodating hole; and
a foot, having a body and a plurality of pads formed in the body, wherein the body is disposed in the accommodating hole and presses against said housing with one of the pads, so as to protrude from the surface of said housing.

2. The electronic device with pad height adjustable as claimed in claim 1, wherein a plurality of notches is formed along the edge of the accommodating hole in the radial direction, and one of the pads presses against said housing while the rest of the pads are respectively nested in each of the notches.

3. The electronic device with pad height adjustable as claimed in claim 1, further comprising an elastomer, disposed in said housing, for bonding the body and said housing and providing an elastic force to make the body press against said housing.

4. The electronic device with pad height adjustable as claimed in claim 3, wherein the elastomer is a tension spring.

5. The electronic device with pad height adjustable as claimed in claim 1, wherein one side of the body is used to contact a plane.

6. The electronic device with pad height adjustable as claimed in claim 1, wherein said foot has three pads, and the thickness of each pad is not equal to the thickness of the rest of the pads.

7. An electronic device with pad height adjustable, comprising:
a housing, with an accommodating hole, wherein a plurality of notches is formed along the edge of the accommodating hole in the radial direction; and
a foot, having a body and a pad formed in the body, wherein the body is disposed in the accommodating hole and presses against one of the notches with the pad, so as to protrude from the surface of said housing.

8. The electronic device with pad height adjustable as claimed in claim 7, further comprising an elastomer, disposed in said housing, for bonding the body and said housing and providing an elastic force to make the body press against said housing.

9. The electronic device with pad height adjustable as claimed in claim 8, wherein the elastomer is a tension spring.

10. The electronic device with pad height adjustable as claimed in claim 7, wherein one side of the body is used to contact a plane.

11. The electronic device with pad height adjustable as claimed in claim 7, wherein the accommodating hole has three notches, and the thickness of each notch is not equal to the thickness of the rest of the notches.
